(19) United States
(12) Patent Application Publication
(10) Pub. No.: US 2010/0077986 A1
(43) Pub. Date: Apr. 1, 2010

(54) Steam Combustion Engine

(76) Inventor: Jack Yajie Chen, Troy, MI (US)

Correspondence Address: Jack Yajie Chen, 1552 Hamlet, Troy, MI, 48084, US

(21) Appl. No.: 12/420,072

(22) Filed: Apr. 8, 2009

Related U.S. Application Data
(60) Provisional application No. 61/100,758, filed on Sep. 28, 2008.

(51) Int. Cl. F02B 47/02

(52) U.S. Cl. 123/25 C; 123/25 K

(57) ABSTRACT

A steam combustion engine is improved from a conventional internal combustion engine by replacing spark plugs with water injection spark plugs, which inject small amount of boiling water into combustion chamber at the beginning of the fuel burning cycle if the engine temperature reaches preset limit. A steam combustion engine controller monitors the temperature of the engine, intercepts and alters fuel injection signal, turns on and off water injection solenoid at the right timing with the right amount. The apparatus can convert conventional vehicle into a steam combustion engine vehicle, reducing fuel consumption and emission by taking advantage of the waste heat and turning water into steam to generate extra useful work. This steam combustion engine can reach 40% efficiency instead of 20% in existing internal combustion engine. This apparatus can be used in any Otto cycle combustion engines found in electric generators, lawn mower, etc besides in most vehicles.

### CROSS REFERENCE TO RELATED APPLICATION

This application claims the benefit under 35 U.S.C. §119(e) of U.S. Provisional Patent Application No. 61/100,758 filed Sep. 28, 2008, where this provisional application is incorporated herein by reference in its entirety.

### BACKGROUND

1. Field of the Invention

This disclosure relates to improved internal combustion engine with a Otto cycle, wherein water is injected into the combustion camber during the power stroke. The burning air-fuel mixture evaporates the water into steam, thereby creating extra pressure to push the piston.

2. Description of Related Art

Over the past one hundred years, Internal Combustion Engine (“ICE” or “IC engine”) has been the major power source for motorized vehicles. A typical IC engine comprises of a plurality of piston-and-cylinder assembles. An air-fuel mixture is forced into the cylinder during the intake stroke cycle, compressed and subsequently ignited and generates high pressure to produce motion energy and waste heat. Due to the enormous amount of waste heat is generated during this process. The efficiency of an ICE is relatively low, typically around 20%.

There have been many attempts to convert the waste heat into mechanical energy, examples of which include the six-stroke cycle IC engine, which injects water into the combustion camber to create an extra power stroke. However, the water injection's effectiveness is very limited and the horse power of the separate water injection cycle is much smaller than fuel combustion cycle, thereby creating an unstable imbalance motion in power-train system. Other attempts to have multiple companion cylinders or turbines to recover waster heat have had limited success since the extra equipment and weight would, ironically, lower the overall efficiency of the vehicle.

Other conventional methods and devices try to introduce water during the compression stroke, which requires dramatic, if not impossible, water pressure from the water pump. It would cause detonation since the combined pressure generated by fuel combustion and water evaporation would be too much in too short period for the piston and power-train system to absorb. Others have tried to inject water even when the engine is cold, which causes inefficient combustion and poor performance. In order to put water injection into practical uses, other conditions also need to be considered when applying the technique, such as recovery strategy when water is frozen or not available.

Recent attempts have been made in the automotive industries to incorporate alternative power source such as electric motor, known as hybrid vehicle. These types of vehicles convert wasted mechanical work during brake or deceleration into electricity for later driving. It improves the so called city mileage per gallon (MPG) significantly. However, it does not address the fundamental wasted heat issue in IC engines. The actual efficiencies of the IC engines in hybrid vehicles do not improve at all.

Holden teaches combined fuel water injector for internal combustion engine in U.S. Pat. No. 7,367,306. It requires significant modification of existing fuel injector which is a critical and expensive part of a vehicle. Because injector space constraint, it is often difficult to retrofit into existing vehicle. It also lacks a feedback mechanism to adjust water injection amount to optimize the efficiency of the engine.

Most recently, Orlosky teaches direct injection of water into combustion engine during the combustion stroke after all or the majority of fuel has burned. This method is less effective because there is little time and the water temperature is too low to evaporate at high speed operation (i.e. 3000 RPM) and it does little to control the extremely high fuel burning temperature which causes NOx emission. It also requires enormous sensing devices and significant modification to make it impractical and expensive to retrofit into existing vehicles.

### SUMMARY

One aspect of this disclosure is to improve the existing vehicle or new vehicle's fuel efficiency by reducing fuel injection amount and supplementing the power stroke by injecting water during the air-fuel mixture ignition cycle if the engine is reaching a high temperature limit. The waste heat is recovered by evaporating the water into pressurized steam mass to generate mechanical work.

A water injection control system monitors the engine temperature, water tank level, fuel injection timing and duration, and spark plug ignition timing. A fuel-injection intercept circuit shortens the fuel injection cycle if water is available and engine temperature reaches predetermined limit, which in an illustrative embodiment is about 120° F. This temperature is maintained for maximized efficiency. The water injection starts at the same time as the ignition. The injection slows down the burning process, which reduces the peak temperature to avoid NOx formation and delay the peak pressure build up so that more useful work can transfer to the crankshaft. It also causes a more controlled and stable flame front. The hydrogen and carbon from hydrocarbon fuel to combine with oxygen has to work around the present water to form OH radicals and CO instead of to form H₂O and CO₂ directly. By slowing this early combustion process, the potential for the mixture to burn too fast and contribute to knock is suppressed. Knocking(detonation) is one of the obstacles to increase engine horse power performance given the same engine size.

Water supply is self-contained in one aspect of the present disclosure. The water is collected through fuel burning exhaust gas, vapor of water injection and by-product of Air-conditioning system. A water collection tank is located in the lower level of the vehicle. It has pipes connected to the end of the exhaust muffler and also pipes connected to Air-conditioning system. Since the engine temperature is controlled at much lower level than traditional internal combustion engine, the exhaust gas quickly cools down below 212° F. boiling point temperature while it travels through the exhaust system, the catalytic converter and the muffler. A significant amount of water can be collected at the end of the exhaust muffler.

In another embodiment, there is also a smaller, heated water supply tank located next to the exhaust manifold. This hot water makes evaporation quicker when it is injected into combustion chamber and it also resolves freezing issue in colder climate environment when air temperature is below freezing level.

Since the engine is running at much cooler level, the traditional cooling system could be much smaller or potentially eliminated. The exhaust gas recirculation (EGR) system can be simplified or even eliminated as well.

In certain embodiments disclosed in this disclosure, modifications are made to existing internal combustion engines by reducing half of the fuel and injecting small amount of water during the burning cycle. The water evaporates with the hot exhaust gas and creates additional pressure and drives the piston travel to the bottom dead center of the cylinder chamber.

### BRIEF DESCRIPTION OF THE DRAWINGS

FIG. 1 is a diagram of one cylinder of a steam combustion engine constructed in accordance with an aspect of the present disclosure in case of retrofitting an existing conventional IC engine.

FIG. 2 is a diagram of one cylinder of a steam combustion engine constructed in accordance with an aspect of the present disclosure in case of a new design engine.

FIG. 3 is a comparison Cylinder Pressure chart between conventional IC engine and SC engine in accordance with an aspect of the present disclosure.

FIG. 4 is a comparison Crankshaft Force chart between conventional IC engine and SC engine in accordance with an aspect of the present disclosure.

### DESCRIPTION OF ILLUSTRATIVE EMBODIMENTS

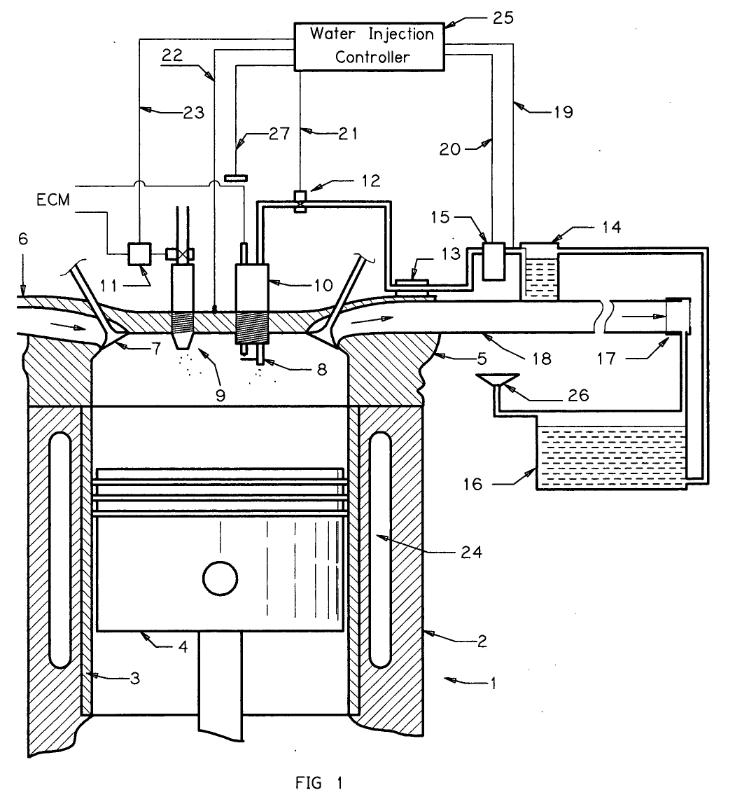

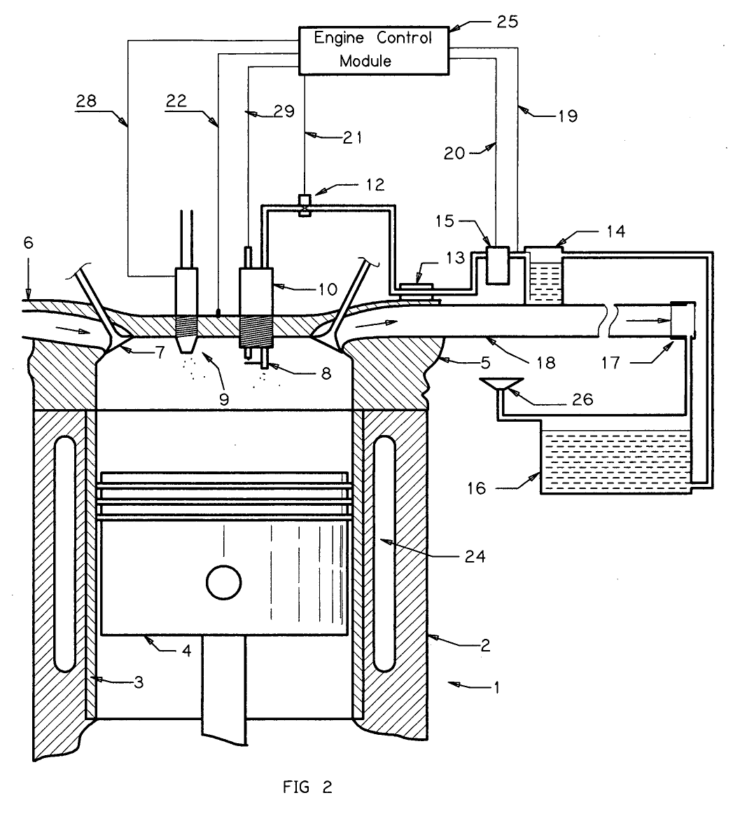

With reference to FIGS. 1 and 2, in which like components in the two drawings are label with the same number, a steam combustion engine 1 in accordance to an aspect of the present disclosure comprises of engine block 2, cylinder 3, piston 4, engine head 5, air intake manifold 6, fuel injector 9, water injection spark plug 10 with water nozzle 8, exhaust manifold 18, lower water tank 16, upper water tank 14, water pump 15 and water injection controller 25.

The engine cycle starts with intake stroke, wherein the piston 4 moves away from the cylinder head 5 creating vacuum, pulling fresh air from the intake manifold 6 through the open intake valve 7. The fuel injector 9 sprays combustible fuel into the combustion chamber. The air/fuel mixture is usually controlled at 14:1 ratio for complete burn.

In the next cycle, compression stroke starts where the piston moves toward the cylinder head compressing the air/fuel mixture. At the end or close to the end of compression stroke, water injection spark plug 10 creates an electrical arc to ignite the high pressure air/fuel mixture and also injects water at the same time.

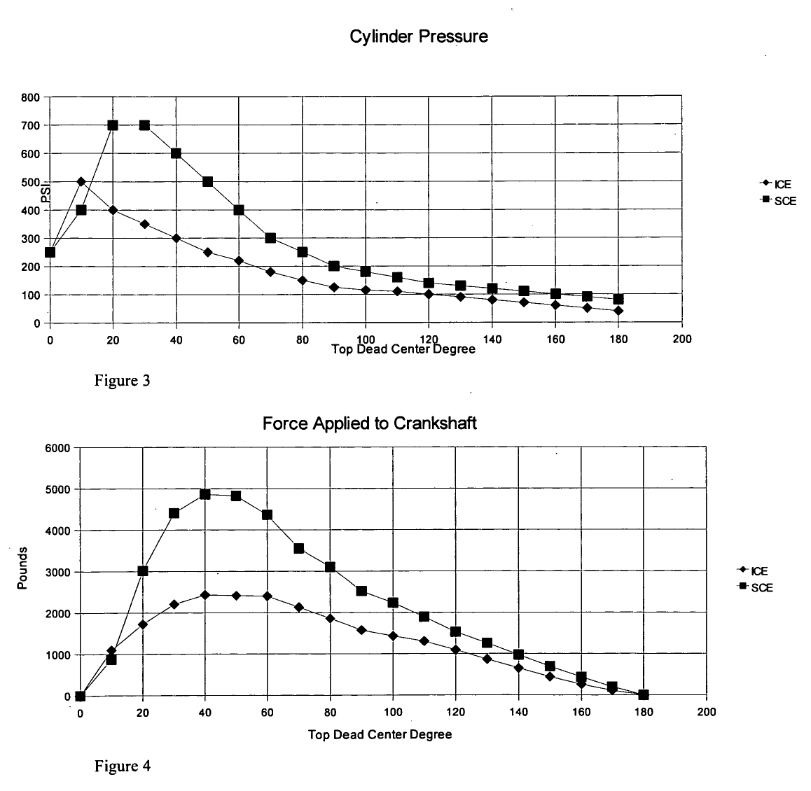

Once the mixture starts burning and exploding, the power stroke starts at the top of the cylinder position. Since water is injected in the air-fuel mixture, the burning cycle is relatively cooler and slower instead of exploding at once as often happens in the conventional internal combustion engine. The maximum pressure occurs later and is maintained longer. It gives a significant advantage to the inventive embodiments as shown in FIG. 3 and FIG. 4. Although the peak pressure only increases by 50%, the average force which is equivalent to total work increases by 100% because of the sine function relationship between the piston force and the crankshaft rotation torque. That translates into doubling of the efficiency of conventional internal combustion engine. The efficiency can reach 40% in this embodiment.

The exhaust stroke is similar to conventional internal combustion engine wherein the fuel exhaust gas and steam exit the combustion chamber through the exhaust value.

The exhaust steam mixture gas passes through catalytic converter and muffler, the temperature drops to below the boiling point at the end of the exhaust pipe. The water collector 17 collects the water into the lower water tank 16. Another water collector 26 collects water from the air-conditioning system when used in the warm climate areas.

The water pump 15 pumps water from the lower water tank 16 to upper water tank 14, wherein the water is heated by the exhaust manifold surface. The water pump 15 supplies water with high pressure (about 150 PSI) into the injection pipes, which is also heated by exhaust manifold surface 13 to the boiling point temperature. High pressure and the steam in the boiling water accelerate atomization of the boiling water when it exits the injection nozzle. The finer droplets quickly absorb the energy in the combustion chamber and evaporate.

The water injection controller 25 monitors engine temperature through thermometer 22, water level sensor 19, spark plug ignition timing sensor 27, fuel injection timing sensor 23 and duration. If the engine temperature reaches preset level, for example 120° F., the water pump 15 is turned on. The fuel injection intercept circuit 11 reduces the fuel injection amount. The water solenoid 12 is turned on when the spark plug fires, and lasts for a duration to provide adequate water injection amount, which is calculated based on the engine temperature and fuel injection amount. The more fuel is injected into the engine, the more water is needed. Typically, the higher the engine temperature, the more water is needed, and vice versa. In one embodiment, the fuel injection amount is approximately the same as the water injection amount by volume, but other fuel/water ratios can be used depending on the engine configuration and size. Since the steam combustion engine has higher efficiency (100% improvement), the fuel injection amount is reduced by 50% replaced by 50% water in the illustrative embodiment. In other words, instead of injecting two units of fuel, the steam combustion engine described in this embodiment injects 1 unit of fuel and 1 unit of water.

The water injection amount can be expressed as the following formula.

water volume=a×f+b×(Te−Tp)

where f is fuel volume, Te is engine temperature, Tp is desired engine temperature, a and b is the coefficient based on engine size and thermal dynamics.

Although the lowered engine temperature reduce the thermal volume of the exhaust gas by say 50%, the additional volume from the water vapor (1,600 times the water volume) creates much higher volume and pressure in the combustion chamber during the power stroke.

Applying the above-illustrated technique to new vehicle design instead of retrofitting an existing vehicle, the water injection algorithm can be integrated with the Engine Control Module (ECM) 25 found in most of the modern Internal Combustion Engine (ICE) as illustrated in FIG. 2, where the fuel injection timing sensor, spark plug timing sensor and fuel injection intercept circuit are not needed. The ECM has an additional input to monitor water tank water level and additional outputs to control the solenoid value and water pump.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A steam combustion engine, comprising:
at least one cylinder assembly which defines a combustion chamber, a reciprocating piston, an intake manifold, an exhaust manifold, fuel injector and a water injection spark plug, the water injection spark plug being configured to ignite the fuel air mixture gas and inject boiling water into the combustion chamber; and
a control unit adapted to calculate the water injection amount based on a temperature of a portion of the cylinder assembly at about the moment the spark plug emits.

2. A steam combustion engine according to claim 1, further comprising a water collection and feeding system comprising two water tanks, a exhaust water collector adapted to collect water originating from the exhaust manifold into at least one of the water tanks; an air conditioning water collector adapted to collect water from an air conditioning unit into at least one of the water tanks; a water injection control valve adapted to regulate water injection into the combustion chamber; and a water pump adapted to deliver water from at least one of the water tanks to the water injection control valve.

3. A steam combustion engine according to claim 1, further comprising a fuel injection switch adapted to shorten the fuel injection amount if engine temperature reaches a preset limit and the water is available for injection.

4. A steam combustion engine according to claim 1, wherein the control unit is adapted to monitor engine temperature, fuel injection signal, spark plug ignition timing, water tank level and to control the water injection control valves and the fuel injection switches.

5. A steam combustion engine according to claim 1, further comprising an engine temperature sensor to supply a signal indicative of the engine temperature, the control unit being adapted to determine water injection amount and fuel reduction amount based on the signal.

6. A steam combustion engine according to claim 1, further comprising a heat exchange system positioned proximate the exhaust manifold and adapted to heat the water supplied to the water injection spark plug.

7. A steam combustion engine according to claim 1, further comprising a solenoid valve adapted to regulate the flow of a high pressure boiling water into the combustion chamber.

8. A steam combustion engine according to claim 1, wherein the control unit integrates into an Engine Control Module, which is adapted to calculate a water injection amount based on engine temperature, and to control fuel air ratio, fuel injection amount, spark plug ignition timing.

9. A steam combustion engine according to claim 8, further comprising a water collection and feeding system comprising two water tanks, a exhaust water collector adapted to collect water originating from the exhaust manifold into at least one of the water tanks; an air conditioning water collector adapted to collect water from an air conditioning unit into at least one of the water tanks; a water injection control valve adapted to regulate water injection into the combustion chamber; and a water pump adapted to deliver water from at least one of the water tanks to the water injection control valve.

10. A steam combustion engine according to claim 8, further comprising a Engine Control Module that monitors the water tank level and controls the water injection control valve.

11. A steam combustion engine according to claim 8, further comprising a heat exchange system positioned proximate the exhaust manifold and adapted to heat the water supplied to the water injection spark plug.

12. A steam combustion engine according to claim 8, further comprising a solenoid valve adapted to regulate the flow of a high pressure boiling water into the combustion chamber.

13. A water injection system for injecting regulated amounts of water into a combustion chamber of an internal combustion engine, the system comprising:
a water injector adapted to placed at least partially in the combustion chamber and to inject water into the combustion chamber; and
a controller adapted to regulate, based on at least one of a timing of ignition of fuel in the combustion chamber and temperature of a portion of the combustion chamber, at least one of the amount, rate and duration of water injection into the combustion chamber through the water injector.

14. The water injection system of claim 13, further comprising a spark plug adapted to ignite combustion of a gas mixture in the combustion chamber, wherein the water injector is disposed in the spark plug.

15. The water injection system of claim 13, further comprising a first reservoir and a water collector adapted to receive water from at least one of an exhaust line connected to the combustion chamber and an air conditioner and pass the collected water into the first reservoir.

16. The water injection system of claim 15, further comprising a second reservoir in fluid communication with the first reservoir, the second reservoir being located between the first reservoir and the water injector and positioned to be heated by a portion of the internal combustion engine.

17. A method of controlling water injection into a combustion chamber of an internal combustion engine, the method comprising:
monitoring an operating condition of a combustion chamber in an internal combustion engine;
injecting water into the combustion chamber; and
based on at the operating condition, regulating the water injection into the combustion chamber.

18. The method of claim 15, wherein regulating the water injection comprises regulating at least one of the amount, rate and duration of water injection into the combustion chamber based on at least one of a timing of ignition of fuel in the combustion chamber and temperature of a portion of the combustion chamber.
